(19) United States
(12) Patent Application Publication
(10) Pub. No.: US 2006/0009990 A1
(43) Pub. Date: Jan. 12, 2006

(54) Method, apparatus, data structure and system for evaluating the impact of proposed actions on an entity's strategic objectives

(76) Inventor: John K. McCormick, West Bend, WI (US)

Correspondence Address: JOHN K. MCCORMICK, 6781 GLACIER DRIVE, WEST BEND, WI, 53090, US

(21) Appl. No.: 10/710,396

(22) Filed: Jul. 8, 2004

(51) Int. Cl. G06Q 99/00

(52) U.S. Cl. 705/1

(57) ABSTRACT

A system and method for tangibly evaluating the impact that proposed daily or long term actions would have on an entity's strategic objectives, or other business goals, prior to implementing those proposed actions is provided by forecasting the probable results of those proposed actions and comparing them to the forecasted results of the existing planned actions. The invention also includes a provision to evaluate the impact of any proposed changes in terms of the changes' offsetting tradeoff impacts. The invention also includes the provision to limit the ability of different users of the system to over-ride the recommended actions based upon the individual user's authority level, based upon the expected results of the proposed actions and/or based upon the tradeoff results on the tradeoff threshold limits. In addition, all of the results and/or limits can be setup as a set of ranges to work within as opposed to just target values.

### SUMMARY OF INVENTION

Accordingly, a need has arisen for a reliable system and a method for evaluating proposed daily and/or long term actions based upon a given action's probable impact on the strategic objectives or goals of the entity. The present invention provides such a system and method by incorporating the entity's existing databases and MIS along with new databases and new software modules. Operatively, the invention forecasts the expected results of the current state of the business process for which a change is desired. An interactive module then allows a user to input the desired changes into the interactive module and forecast the expected results of the modified business process. Comparing the two expected results against each other in the same measure that is directly or indirectly related to the strategic objective or goal provides a means to evaluate how the proposed changes would most likely impact the strategic objectives.

Additional improvements derive from this invention with the addition of a means for monitoring the possible tradeoffs that come with any proposed business process change and placing tradeoff threshold limits on these tradeoffs. This provides a means for balancing the improvements that might arise from a given business process change with the tradeoffs associated with a given business process change.

An additional improvement derives from this invention by the optional use of ranges for the strategic objectives or goals and/or the use of ranges for the tradeoff threshold limits. This improvement allows users a window or area to operate in while making their decisions, rather than through the use of absolute targets.

Another additional improvement is the optional use of varying levels of the ranges within which various users can be authorized to act within, those levels being constrained by the level of authority the individual user is allowed and the levels set for the strategic objectives or goals and the levels set for the tradeoff threshold levels.

### BACKGROUND ART

In almost all industries and endeavors, whether that endeavor is manufacturing, service, governmental or otherwise, the leaders of a given endeavor develop strategic plans which are used to lead and guide the people engaged in the endeavor. Basically, strategic plans are a set of objectives the leaders desire to pursue and achieve in order to be successful in their pursuits.

The strategic objectives developed are as varied and distinct as there are number of entities. Each entity develops their own strategic objectives based upon their knowledge and beliefs about their industry, their business and their resources. However, many strategic objectives will relate in one form or another to such common concerns as increasing sales, reducing costs, complying with industry regulations, reducing injuries, developing new products, services or markets, reducing lead-times for shippable products, improving profits and/or a host of other objectives that the leaders expect will improve their position financially and within their industry. Some companies also develop strategic objectives based upon being responsible corporate citizens and on being environmentally active.

Most strategic plans are developed on a yearly basis typically concurrent with the financial cycle, probably because the financial books of an entity are based upon a twelve month cycle for financial and tax reasons. Some entities also have long range strategic plans going out 4, 5 or more years and mid-range plans that go out 2 to 4 years. However, the yearly strategic planning cycle is pretty much universally used by most entities.

In most entities the strategic objectives are further broken down into more specific goals that the company and/or individual areas within the company are expected to achieve. For example, if an entity had as its primary strategic objective to increase profitability, the sales department may have a goal to increase overall sales by 10%, engineering may have a goal to develop and introduce three new products by year end, claims processing might have a goal to improve the speed of processing claims, maintenance may have a goal to reduce maintenance costs while maintaining up time of the equipment, and so on. Once the area or departmental goals are established, those areas then develop their action plans with the steps that they believe must be taken in order to achieve the departmental or area goals, and subsequently support and achieve the strategic objectives.

Once the strategic plan, with objectives, goals and action plans, are in place, the organization works to implement those plans throughout the coming year. Meanwhile, on a daily basis, the rest of the organization is going about the process of running the day-to-day business. For most entities, this is typically done by utilizing a computerized Management Information System (MIS). These MISs are, in a very broad sense, similar from industry to industry and company to company. Whether the industry is banking, health care, insurance, investment management, manufacturing, service, government or any other entity, the MISs are designed to acquire, store, manipulate and output the information deemed relevant to the industry and the specific user.

For example, in the health care industry, the MIS may contain information on such things as patients, health care professionals, medication inventory and usage, costs, incomes, patient care records, compliance records and a host of other information deemed relevant for treating the patients and for managing the business. Similarly, a bank may have an MIS that contains information on such categories as customers, employees, assets, liabilities, income, expenses, investments, compliance records, investment options and performance, loans outstanding and so on for information deemed relevant to satisfying their customers and to effectively manage the business. As another example, manufacturing will typically have such information as current, historical and forecasted sales levels, customer information, supplier information, inventory availability, production performance records, product costs, financial records, human resource records and a host of other data contained within their MIS related to serving their customers and managing their business. In each of these industries, and others, the MIS contains the databases and software used to manipulate the data in order to provide relevant informational outputs.

These MISs are all similar in many ways. They will all have financial modules for tracking and recording the financial affairs of the entity. The MIS will have modules for scheduling and tracking work whether that work is check processing, loan processing, patient scheduling, inventory and distribution of goods and/or services, manufacturing or any other kind of work. They may also have means for entering and tracking sales, warranties, human resources issues and other specific categories of interest related to any given concern. These systems are well known and well practiced in the art. Unfortunately, they all suffer from the same maladies and inconsistencies.

While an entity will have a strategic plan with strategic objectives, goals, and an operational plan and/or action plans, the entity is also operating the day-to-day business based upon the existing MISs. Unfortunately, the MISs have been around for a substantial period of time and the parameters under which they operate are, for the most part, fixed based upon previously defined perceptions of what was important to manage the entity by. As a general rule, that fixed parameter has been costs.

For example, in a manufacturing environment there is what is called a Manufacturing Resource Planning module (MRP II) as a part of the MIS. This module performs a number of functions, one of which is to determine the number of parts to run in a given work order. The answer of how many parts to run in a given order is determined by the Economic Order Quantity (EOQ). Basically, the EOQ balances the cost for setting up and running the part against the cost of carrying excess inventory over time. By balancing these costs, the manufacturing company arrives at the optimal lot run size to keep costs at a minimum. Similarly, a distribution company will have modules for the purchasing and inventorying of goods that it distributes using the EOQ formula or a slightly modified EOQ in order to minimize their purchasing costs by balancing those costs with the inventory carrying costs. The distribution company will also closely monitor the sales and turnover of the goods in inventory. The greater the inventory turns, the less inventory investment cost there is to the company.

Similar cost containment issues are found when one looks at the banking industry, health care, insurance, stock brokerages, and other industries. The existing MISs are embedded with fixed parameters for providing guidance and recommendations on the day-to-day decisions of the endeavor, independent of the strategic objectives. The result of this is that while an entity may have defined their strategic objective as increasing market share, or improving profits or any other strategic objective other than reducing costs, the rest of the organization is going about their day-to-day business making decisions based upon an MIS that is structured to allocate work and to make recommendations based primarily upon cost containment.

Twenty years ago, cost control was a significant and vital part of any entity's strategic plans. However, with the advent of international trade agreements such as NAFTA, the shift to the globalization of business and work, and the changes brought on by improvements in telecommunications, internet business and new technology, many businesses have had to significantly change their strategic plans to accommodate for the changed business and competitive structures. That change has continued and will continue, forcing organizations to continually adapt and change their business strategies.

For example, in the United States a manufacturer or distributor today may be paying $15.00 to $25.00 or more per hour for a laborer, while in China that same laborer is getting paid less than $1.00 per hour. Obviously, given the wage rate, there is very little likelihood that a United States company can compete with an identical company located in China on costs. As a result, many companies have switched their primary strategic focus from cost reduction to some other strategic advantage.

One such switch was for companies to focus on reducing quality problems. Another switch was to focus on reducing lead-times to customers without adding inventory. Another switch was to strategically focus on improving profitability. These and many other strategic direction changes have significantly changed how business is operating and what they are pursuing in order to survive and grow their businesses.

However, for all of these changes and redirections of a company's strategic plan and focus, the IMS underlying the day-to-day activity of the business has remained virtually unchanged. For example, MRP II is unchanged and the use of the EOQ is still being applied to keep costs low and drive the daily decisions on how many goods should be ordered or produced even when the primary strategic direction is something other than keeping costs low. In fact, the use of an EOQ when a company's strategic direction is something other than lowering costs many actually hinder the company's efforts to achieve their strategic objectives.

The result of this is that the MISs are providing information and direction to people on a daily basis that is not consistent with the strategic direction of the entity. In many cases, the MIS does not provide for any recommendations relative to the strategic objective of the company. A couple of examples will be presented here for clarification purposes. For the first example, we will start by assuming there is a distribution company that has as its primary strategic objective the goal of reducing lead-times of customer's orders, under the assumption that reduced lead-times would result in greater profits caused by increased sales. In the distribution company, as in all industries, the sales group is responsible for getting sales orders into the company. The sales modules within a distribution company's MIS are designed and setup for the sales department to input new sales orders, track the status of orders, monitor sales in a variety of ways and provide many other functions related to the activity of sales. However, nowhere in the MIS sales module, or anywhere else in the MIS, is there a means to look at the impact of a given sales order on the company's primary strategic objective. The MIS does not provide for a means for looking at the probable impact that a single order would have on the company's lead-times before the order is accepted and implemented. Worse yet, even after the order has been accepted, processed and shipped there is still no means to determine the impact that a given order had on the company's primary strategic objective of reducing lead-times. This is true for any strategic objective a company might have with the exception of a strategic objective to increase sales orders, since that is primarily what the sales module in the MIS tracks.

As a second example, a production area in a manufacturing company that has as its primary strategic objective the goal of increasing profits will be utilized. In the production area, the employees receive from the MIS a proposed production schedule typically generated by an MRP II module. This module it designed to schedule work based upon scheduling the oldest order first, whether or not that helps to increase profitability or reduce it. In addition, once the production area receives the planned schedule, the employees review the schedule and change it, sometimes many times during a single work shift. There are many reasons for these schedule changes. Equipment can be inoperable, people that were scheduled to work did not show up or, in many cases, the people look at the schedule and see that there are a variety of jobs that are very similar to each other and some that are very different for each other. In order to be more efficient and productive, which is what the production areas are held accountable for, they change the schedule to put similar jobs together in order to reduce setup and changeover time. Unfortunately, they have no means for determining the impact of these proposed changes on the primary strategic objective of increasing profitability, either before or after they implement the change.

In addition, there are many occasions when the sales group in a manufacturing business gets in a customer order and, for whatever reason, they want to have that specific order moved up in the production schedule. Since there is presently no means for analyzing the potential impact on the primary strategic objective of increasing profitability before implementing that change, and no means to evaluate the actual impact after the change, the actual decision of whether to change the schedule or not revolves on either teamwork, politics or power, not on whether pushing that sales order up in the schedule supports the primary strategic objective of improving profits or not.

Many other examples could be provided in all kinds of businesses and endeavors including banking, health care, insurance, brokerages, government, educational institutions and so on. The fundamental problem with the current MIS being used in any endeavor is that the MIS provides no means for evaluating the impact of any proposed action on the strategic objectives of the entity. As such, hundreds of decisions and actions are being made daily that work against an entity's strategic objectives.

In addition, outside of the strategic objectives and other planning activities, entities are constantly looking at other endeavors that might possibly improve the position of their business or activity. They might be looking at acquiring a competitor, or acquiring a business with a complimentary product line. They may be looking at relocating, or opening up branch offices nationally or internationally. They may be looking at adding floor space or additional capacity in an existing facility. Unfortunately, this too is typically looked at only from a financial aspect. That being, what are the associated costs and what will the expected returns be. If an entity has a long range strategic objective of gaining 75% of a given market, each and every one of the aforementioned activities may help contribute to achieving that objective. However, each and every one of those same activities may just as likely contribute to not achieving that long term objective. There is no process or means within existing MISs to input the proposed activities and see what the probable outcome of those activities are on the long term strategic objective prior to implementing them.

A technical problem in connection with strategic planning or operational planning and the daily activities is that there is no knowledge of an effective means for forecasting the probable results of the current planned daily work and comparing that result to some proposed change to the existing daily work in a mode that ties the results of those two differing actions to the strategic objective of the entity, and as such there is no way to know which of the actions is most supportive of the strategic objective of the entity prior to making a decision as to which action should be implemented. Furthermore, there is no technical way look at the proposed actions after they are implemented to determine how those actions impacted the strategic objective in any substantive way since there is no means by which the results of the implemented actions can be compared to the original actions that were not implemented. Therefore, there exists a demonstrated need for a system that is able to look at the proposed actions that an entity may be considering for implementation and evaluate those actions against the entities existing work and their strategic objectives or business goals in a manner that evaluates the probable results of executing the existing work and the probable results of proposed actions as against the strategic objectives or business goals that the entity deems important.

### BEST MODE FOR CARRYING OUT THE INVENTION

To facilitate the description of the invention, it is worthwhile to define some terminology solely for this purpose. This terminology is somewhat arbitrary and should not be construed as limiting the generality of the invention. For the purposes of this description:

1. Strategic objective are meant to include any and all desired goals, end results, improvements and/or directions that the entity desires to move toward and/or achieve. Strategic objective is meant to include both the singular and plural sense of the word.

2. Planning period is a time frame meant to include the existing orders or work schedule, however the planning period could use or include the current forecastable planning period and/or any other planning period, including a historical planning period, chosen by the user.

3. Tradeoffs are meant to include any and all possible negative consequences that might, or in fact do, occur as a result striving to achieve the strategic objectives. In the alternative, a tradeoff could be a positive result that occurs even though the proposed action has a negative or insignificant effect on the strategic objective measure. A tradeoff can also include secondary or alternative strategic objectives.

4. Tradeoff threshold is meant to mean a desired limit for the tradeoff for which the tradeoff measure value is not to cross over or exceed.

5. Work is meant to include any endeavor that the entity puts resources into in order to accomplish some desired result. Work could be such things as consulting, legal aid, purchasing, check processing, health care, production, filming art and a myriad of other activities.

Reference will now be made in detail to the description of the invention as illustrated in the drawings. Although the invention will be described in connection with these drawings, there is no intent to limit the invention to the embodiment or embodiments disclosed therein. On the contrary, the intent is to include all alternatives, modifications and equivalents included within the spirit and scope of the invention as defined by the appended claims.

Furthermore, the order of the itemized steps in FIG. 3 and FIG. 4 are not meant to limit the scope of the invention to the specific itemized order of those steps, but rather to include those steps in any relevant order including any alternatives, modifications and equivalents included within the spirit and scope of the invention as defined by the appended claims.

To aid in the understanding of the invention, examples of some of the specific itemized steps are provided for clarification purposes only. These examples are not meant to limit the invention to the method disclosed or to the businesses used in the examples, but rather to include any entity and any alternative, modification and equivalents included within the spirit and scope of the invention as defined by the appended claims.

FIG. 1 illustrates the overall topology of an organizational entity 1 depicting the primary elements and/or interactions relevant to the invention. The five main elements in the organizational entity 1 are the strategic plan 2, the organizational structure 6, the Management Information System (MIS) 10, the daily business activity 12 and the system for evaluating the impact of proposed actions 15 on the strategic objective and measures 3. Internal to the organizational entity 1 is the strategic plan 2. The strategic plan 2 consists of strategic objectives and measures 3. From the strategic objectives and measures 3, corporate and departmental action plans 4 are developed.

The organizational structure 6 is responsible for two distinctly different activities. One of those activities is to implement the strategic plan 7 and the other is to manage that daily business activity 8. In order to implement the strategic plan 7 and strive to achieve the strategic objectives 3, information, decisions and data flows 5 both ways between the organizational structure 6 and the strategic plan 2. Similarly, in order for the organizational structure 6 to manage the daily business 8, information, decisions and data flows 9, 11 and 13 both ways between the organizational structure 6 and the MIS 10, between the organizational structure 6 and the daily business activity 12 and between the MIS 10 and the daily business activity 12. Obviously, relevant information on implementing the strategic plan 7 and managing the daily business 8 is shared by the organizational structure 6. However, in the existing organizational structure 6, there is no means for evaluating and/or analyzing the shared information to assure that the management of the daily business 8 is supporting and consistent with the implementation of the strategic plan 7.

According to this invention, a system for evaluating proposed actions 15 is put in place wherein proposed actions from the daily business activity 12 can be sent 14 to the system for evaluating the proposed actions 15. The system for evaluating proposed actions 15 then gathers 16 data and information from the strategic objectives and measures 3 and gathers 17 data and information from the MIS 10. In a very broad sense, the details of which will be explained later, the system for evaluating proposed actions 15 then evaluates the existing actions and the proposed actions in light of the strategic objective measures 3 and provides guidance or direction as to the implementation or non-implementation of the proposed actions which flows 14 back to the daily business activity 12. The guidance or direction is also provided 17 to the MIS 10. The guidance or direction from the system for evaluating proposed actions 15 flowing 14 and 17 back to the daily business activity 12 and the MIS 10 can also flow 13 and 9 back to the organizational structure 6 through the MIS 10, or in the alternative directly (not shown), for reporting, tracking and/or evaluation by the organizational structure 6.

In an alternate embodiment (not shown) the organizational structure 6 responsible for implementing the strategic plan 7 and for managing the daily business 8 could also input proposed actions into the system for evaluating proposed actions 15 in order to evaluate the proposed actions impact on the strategic objective measures 3 prior to implementing the proposed actions.

FIG. 2 illustrates a system for evaluating proposed actions 15 for the probable and potential impact a given action would have on a strategic objective of an organization, or on any other goal of an organization in accordance with the present invention. The apparatus 18 used to determine the impact of proposed actions on the strategic objective or a goal may be embodied in any computing device, such as a personal computer or work station, as modified to carry out the features and functions of the present invention. As shown in FIG. 2, the system contains a processor 19, such as a central processing unit (CPU), and memory 20, such as RAM and ROM. Stored in the memory 20 are the original databases 21 and the Management Information System (MIS) 22. Within the MIS 22 are a variety of software modules or programs (not shown) used in the course of the entity's endeavors. Also included in the memory 20 are additional new databases 23 and the new modules 24.

In an alternative embodiment, multiple computing devices 18 could be utilized to host and accomplish whole parts, or individual portions, of the processor 19, memory 20, databases 21, MIS 22 software, new databases 23 and/or the new modules 24 so long as the multiple computing devices 18 were operably connected.

As shown in FIG. 3, the process for determining the impact a given action may have on a strategic objective starts with establishing the strategic objectives 25 for the organization. In its preferred embodiment, once the strategic objectives 25 are defined, the organization's strategic objectives 25 are prioritized 26 and a primary strategic objective 27 identified. Following the determination of the primary strategic objective 27, a list of possible measures 28 for the primary strategic objective 27 are developed and the primary strategic objective measure 29 for the primary strategic objective 27 is selected.

Next the existing databases 21 and MIS 22 are accessed and the existing databases temporarily reset 30 as if the work in the planning period has in fact been completed per the existing MIS 22 structure. In an alternate embodiment, the existing databases 21 could be copied to a new set of databases 23 and this new set of databases reset 30 as if the work had already been completed for the planning period. In either event, the MIS 22 or a copy of the MIS 22 in the new modules 24 is then run and the first expected strategic objective results calculated 31 using the primary strategic objective measure 29 and using the reset databases 30 for the desired planning period.

For example, if the primary strategic objective 27 was to reduce the lead-times to customers and the primary strategic objective measure 29 was number of days from customer order to customer shipment, then the existing databases 21 could be copied to a new set of databases 23. The new databases 23, including the work schedules, inventories, job routings, planned purchases and so forth could be reset 30 as if the work had been accomplished per the existing MIS 22 software routines. All of the financial reports, production reports, shipping reports and so on could be then calculated 31 as if the work had actually been completed and the expected lead-times for customer orders could be forecasted and stored in the new databases 23.

The next step is to create an interactive version of the databases wherein people are allowed to temporarily change the interactive databases 32. When an entity proposes to make a change to the existing database, they input those changes to the interactive database and then run the relevant MIS 22 modules as if those changes had actually been made and the work was completed. From this, the second modified expected strategic objective results 33, as measured by the primary strategic objective measure 29, as well as the set of financial reports, production reports, shipping reports and so on could then be calculated 33 as if the changed work had actually been completed.

The first expected strategic objective results 31 could then be compared 34 to the second modified strategic objective results 33. If the proposed changes are an improvement 35 as measured by the primary strategic objective measure 29, then the process would allow the proposed changes to over-ride the original databases with the proposed changes 37. If the proposed changes did not show an improvement 35 as measured by the primary strategic objective measure 29 then the proposed changes would not be allowed to over-ride the original database 36.

Continuing with the prior example of reducing lead-times for customer orders, if a sales department wanted to push in a specific sales order they just brought in and rush it to the customer by putting it ahead of other orders already in the work schedule, they could access the interactive databases, reschedule the specific job ahead of other planned work, and run the relevant MIS. This would then provide them with the expected results to lead-times resulting from the changed schedule. This second expected result could then be compared to the first expected results from the earlier MIS run. If the change was lead-time neutral or provided an improvement to lead-times, the change could be implemented into the original schedule. If the result was a detriment to improving lead-times, then the change would not be permitted.

The actual timing of the first MIS run on the existing databases to calculate the first expected strategic objective results 31 could be run at any time. This run is utilized to create the standard against which any other proposed changes or modifications to the databases can be compared. As such, this first run could be done prior to work starting, it could be re-run every hour or after any accepted proposed change or whenever else it is so desired.

The proposed changes to the interactive databases and the running of the MIS 33 using the modified interactive databases should be run in such a manner that the feedback is prompt. Since the first expected results 31 are already known; it is a simple matter to have the apparatus and process compare the first and second expected results 31 and 33 and provide a means for the user to know if the proposed modifications are accepted or rejected. The acceptance or rejection of any proposed change could be signified in a variety of ways such as color coding, providing the actual forecasted improvement or detriment, or through a variety of other means.

In an alternate embodiment, shown in FIG. 4, additional steps are added to the software and the process. Following the step of selecting the primary strategic objective measure and putting the measure in place 29, the step of identifying the tradeoffs to the primary strategic objective are defined 38. Next, the tradeoffs are prioritized 39, and the primary tradeoff selected 40. The possible tradeoff measures are identified 41 and the primary tradeoff measure selected and put in place 42. In its preferred embodiment, a threshold for the primary tradeoff is established 43.

Continuing with the prior example, the possible tradeoffs 38 to the primary strategic objective 29 of improving lead-times could be such things as not increasing the inventory levels, maintaining the existing product and/or service cost structures, not losing sales volume, assuring that some orders are not put on semi-permanent hold status, or some other tradeoff. If the primary tradeoff 39 was selected as not increasing inventory and the dollar value of inventory was chosen as the tradeoff measure 42, then there could be a threshold value 43 as to how much of an increase would be acceptable as long as the primary strategic objective 29 was achieved. For example, if the primary strategic objective 29 was to reduce lead-times by five days, the tradeoff threshold 43 could be zero dollar increase in inventory, or it could be that a $5000.00 increase in inventory would be deemed acceptable, or some other number.

In an alternate embodiment, the tradeoff 39 could be a positive result to the entity even though the proposed action is a detriment to the primary strategic objective 29. For example, if the proposed action caused an increase in the lead-times by one day, but the overall profit increased by $5000.00 or more, then the action could be allowed even though it results in a detriment to the primary strategic objective 29 of reducing lead-times.

The tradeoff measures 41 recognize that there are always two sides to a coin. In striving to achieve one objective, one should not be blind to the methods and consequences used to achieve those objectives. There is a balance to be arrived at in defining what, or how much, one is willing to give up on the one hand, in order to achieve the primary strategic objective 29 on the other hand.

Continuing with FIG. 4, after the step of running the MIS to calculate the first expected strategic objective results 31, the step of using the modified databases to calculate the first expected tradeoff results 44, as measured by the primary tradeoff measure 42, is added. Then, after the step wherein a proposed change to the interactive databases is made and the second expected strategic objective results are calculated 33, the step of using the modified interactive databases and the prior MIS run to calculate the second expected tradeoff results 45, as measured by the primary tradeoff measure is added.

After the next step of comparing the first strategic objective results with the second strategic objective results 34, the step of comparing the first expected tradeoff results with the second expected tradeoff results 46, based upon the primary tradeoff measure 42, is added to the process. Then, if the second expected strategic objective results show an improvement, when compared to the first strategic objective results 35, then the step of determining if the difference between the first and second tradeoff results exceeds the predefined tradeoff threshold measure 47 is added. If the tradeoff threshold measure is exceeded, then the step of not allowing the proposed database changes to over-ride the original data base 48 is added. If the difference between the first and second tradeoff measure results does not exceed the tradeoff measure threshold, then the proposed databases changes are allowed to over-ride the original databases 37.

In a further embodiment, the operational objectives and goals could be substituted for the strategic objectives and goals. In another embodiment, the objectives, goals and/or tradeoff thresholds could be defined as a range of values rather than an absolute objective goal and/or threshold. For example, the goal of reducing lead-times could be three to seven days reduction rather than the five day reduction used in the earlier example. Similarly, the threshold of no more than $5000.00 of increase to inventory could be set as no more $3000.00 to $5000.00 of increase in inventory. In another alternative, the tradeoff threshold could be set as a ratio of the desired goal to the tradeoff threshold such as no greater than $1000.00 of increased inventory for every one day of lead-time reduction. Other variations and alternatives would be obvious to a practitioner skilled in the art.

As another alternate embodiment, the apparatus and the process could be set up such that there are varying levels of tradeoff thresholds and overrides to the proposed allowance or non-allowance of any proposed changes to the original databases based upon the level of responsibility and/or authority of the individual. For example, an operator may have a very low threshold for which they may not be allowed to over-ride while a supervisor and a manager may have a much higher threshold within which they may operate. In our prior example the threshold for increasing inventory may be limited at only $50.00 for the operator, but could be set at $400.00 for a supervisor and $1000.00 for a manager. Thus, differing levels within the organization would have differing authority levels on which they could impact the strategic direction and the tradeoffs the entity is attempting to manage.

While in the foregoing specification specific examples were used for illustration purposes, it will be understood that the present invention is not to be limited by those examples and that many of the process steps defined in the specification can be rearranged, modified, partly eliminated or varied considerably without departing from the scope and spirit of the invention.

It is to be understood that the embodiments and variations shown and described herein are merely illustrative of the principles of this invention and that various modifications may be implemented by those skilled in the art without departing from the scope and spirit of this invention. The spirit of the invention is to establish a means for evaluating and aligning a entity's proposed actions with its strategic objective such that the business activity's operational side of the entity is supporting and consistent with the strategic direction of the entity.

There are many significant and profound benefits that result from the present invention, only a few of which are listed below. As one example, it now becomes possible to tangibly evaluate, compensate and/or reward individuals whose efforts are consistent and supportive of achieving the strategic objectives of an entity, without regard to personal opinion or intangible and non-objective evaluations. The sales force can now be compensated on their tangible and measurable ability to support and achieve the strategic objectives of the entity rather than how much sales they bring in. As another example, an enormous amount of management and leadership time can now be freed up to do other management activities since their time will no longer be consumed with most of the daily decision making issues as the employees can tangibly test any changes they may want to pursue to evaluate the probable outcomes as it relates to the entity's strategic objectives prior to implementing the proposed changes. This enables the employees to know if their proposed changes are supportive the entity's strategic objectives or not, without consuming managements time in the daily decision making process. An added benefit of this is that the employees gain more decision making ability, however, that ability is constrained by the requirement of only making decisions that support the strategic objective of the entity.

As another example, many of the issues that consume management's time today involves multiple departments and managers debating over possible decision options and alternatives while each manager is trying to optimize their own area of responsibility. The invention presented will eliminate much of that discussion and debate as it is now easy to see and verify the impact of possible decisions on the strategic objective of an entity without getting bogged down in individual area concerns, politics or priorities. On a larger scale, this invention allows for executives or managers to evaluate possible long term strategic actions, such as adding facilities, acquiring a competitor or other issues, on the probable strategic results of those actions over a longer period of time. Other benefits would be apparent to one skilled in the art.

### BRIEF DESCRIPTION OF THE DRAWINGS

For a further understanding of the nature and objects of the invention, reference should be made to the following description and appended claims, taken in conjunction with the accompanying drawings, in which like elements are given the same reference numbers. It is to be understood that these drawings depict only the typical embodiments of the invention and are, therefore, not to be construed as limiting the scope and spirit of the invention.

FIG. 1 provides an overview of the general topology of the invention;

FIG. 2 illustrates an apparatus in accordance with the present invention;

FIG. 3 is a flow chart describing an means for aligning work to be consistent with and supportive of the strategic objectives; and

FIG. 4 is a flow chart of an alternated means for aligning work to be consistent with and supportive of the strategic objectives.

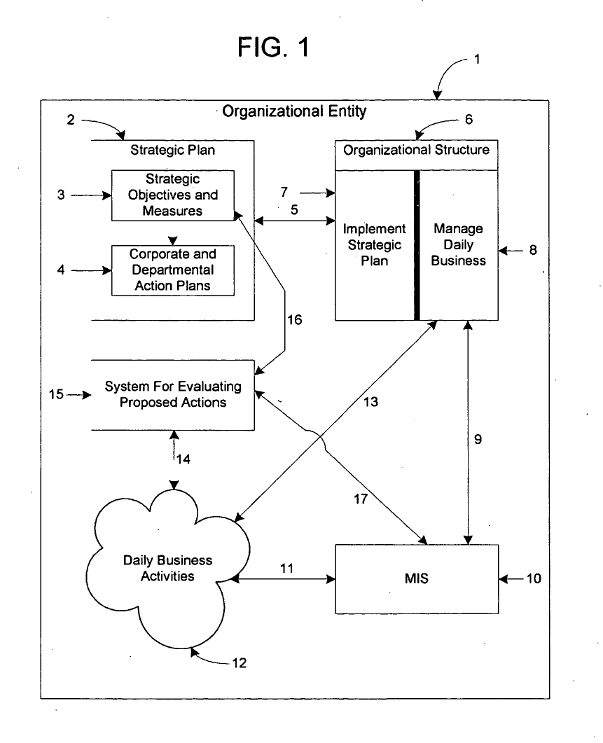

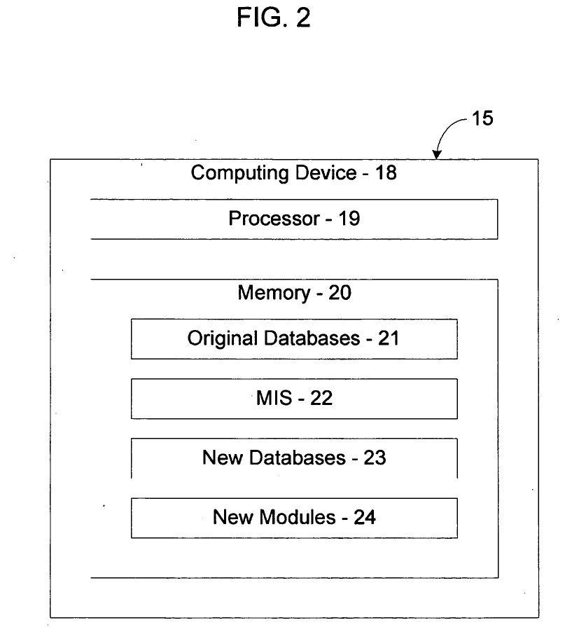

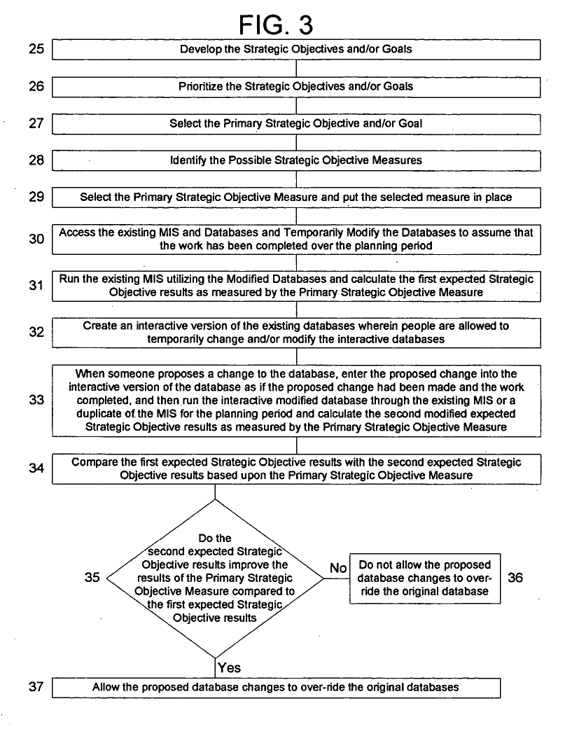

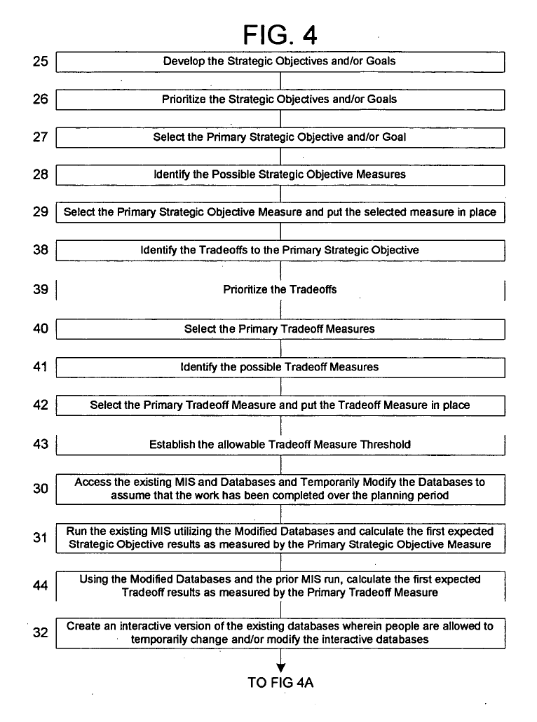

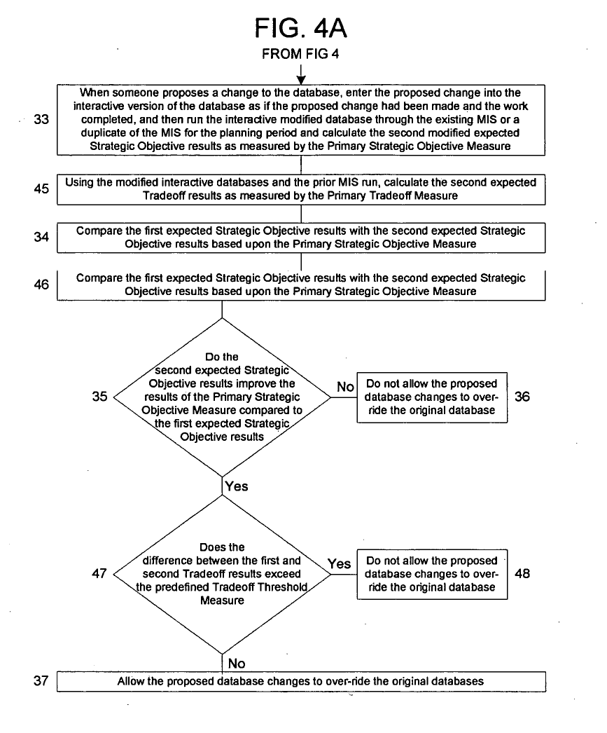

I claim:

1. A method for determining if proposed modifications to existing planned activities are supportive of and consistent with an entity's strategic objective, comprising the steps of:
a. defining the strategic objectives;
b. prioritizing the said strategic objectives;
c. selecting the primary strategic objective;
d. selecting and saving a desired target value for the said primary strategic objective;
e. identifying the possible measures for the said primary strategic objective;
f. selecting the primary strategic objective measure;
g. determining the formula for calculating the said primary strategic objective measure if the said primary strategic objective measure does not already exist and saving the said formula for calculating the said primary strategic objective measure;
h. temporarily modify the original databases to assume that the work or activity yet to be completed has been completed over a planning period and saving the modified databases;
i. calculate the first expected results using the said modified databases as measured by the said primary strategic objective measure over the said planning period and saving the said first expected results;
j. create an interactive version of the said original unmodified databases wherein users are allowed to modify the said interactive databases;
k. use the said modified interactive databases to calculate the second expected results caused by the said interactive database modifications as measured by the said primary strategic objective measure for the said planning period and temporarily save the said second expected results;
l. compare the said first expected results with said second expected results to determine if the said modifications to the said interactive database caused an improvement, a deterioration or was impact neutral to the said strategic objective target value and temporarily save the said comparison result;
m. save the said modifications to the said interactive databases into the said original databases if the said second expected results or the result of the said comparison between the said first expected results and the said second expected results was an improvement to achieving the said strategic objective target value;
n. do not save the said modifications to the said interactive databases into the said original databases if the said second expected results or the result of the said comparison between the said first expected results and the said second expected results was a detriment to achieving the said strategic objective target value;
o. save or not save, the choice of saving or not saving to be determined by the said entity, the said modifications to the said interactive databases into the said original databases if the said second expected results or the results of the said comparison between the said first expected results and the said second expected results was impact neutral to achieving the said strategic objective target value; and
p. periodically save the said modifications to the said interactive database into the said modified database and into the said interactive database if the said modifications were stored in the said original databases and repeating steps h, i, j, k, l, m, n and o above.

2. A method as recited in claim 1 [c1], wherein said method comprises:
a. identifying the tradeoffs to the said primary strategic objective;
b. prioritizing the said tradeoffs;
c. selecting the primary tradeoff;
d. identifying the possible primary tradeoff measures;
e. selecting a primary tradeoff measure and saving the formula for calculating the said primary tradeoff measure;
f. selecting the allowable tradeoff threshold limit for the said primary tradeoff measure and saving said allowable tradeoff threshold limit;
g. calculate the first expected tradeoff results as measured by the said primary tradeoff measure using the said modified databases and save the said first expected tradeoff result;
h. calculate the second expected tradeoff results as measured by the said primary tradeoff measure using the said modified interactive databases and save the said second expected tradeoff result;
i. compare the said first expected tradeoff result with the said second tradeoff result to determine if the modifications to the said interactive databases caused an improvement, a deterioration or was impact neutral to the said first tradeoff result and store the said the result of the said comparison between the said first expected tradeoff result and the said second expected tradeoff result;
j. save the said modifications to the said interactive databases into the said original databases if the said second expected result or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold limit;
k. do not save the said modification to the said interactive databases into the said original databases if the said second expected results or the result of the said comparison between the said first expected results and the said second expected results was a detriment to achieving the said strategic objective target value or if the said second tradeoff result or the result of the said comparison between the said first expected tradeoff result and the said second expected tradeoff result violated the said allowable tradeoff threshold limit; and
l. save or not save, the choice of saving or not saving to be determined by the said entity, the said modifications to the said interactive databases into the said original databases if the said second expected results or the result of the said comparison between the said first expected results and the said second expected results was impact neutral to achieving the said strategic objective target value and if the said second expected tradeoff results or the result of the said comparison between the said first expected tradeoff result and the said second expected tradeoff result was impact neutral to the said allowable tradeoff threshold limit.

3. A method as recited in claim 1 [c1], wherein the said method comprises:
a. setting an allowable range for the said strategic objectives target value and saving the said allowable strategic objective range;
b. saving the said modifications to the said interactive databases into the said original databases if the said second expected result or the result of the said comparison between the said first expected results and the said second expected results was an improvement to achieving the said allowable strategic objective range;
c. not saving the said modifications to the said interactive databases into the said original databases if the said second expected results or the result of the said comparison between the said first expected results and the said second expected results was a detriment to achieving the said allowable strategic objective range; and
d. saving or not saving, the choice of saving or not saving to be determined by the said entity, the said modifications to the said interactive databases into the said original databases if the said second expected results or the result of the said comparison between the said first expected results and the said second expected results was impact neutral to achieving the said allowable strategic objective range.

4. A method as recited in claim 2 [c2], wherein the said method comprises:
a. setting an allowable range for the said allowable tradeoff threshold limit and saving the said allowable tradeoff threshold range;
b. saving the said modifications to the said interactive databases into the said original databases if the said second expected result or the result of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold range;
c. not saving the said modifications to the said interactive databases into the said original databases if the said second expected results or the result of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff threshold range; and
d. saving or not saving, the choice of saving or not saving to be determined by the said entity, the said modifications to the said interactive databases into the said original databases if the said second expected results or the result of the said comparison between the said first expected results and the said second expected results was impact neutral to achieving the said strategic objective target value and if the said second expected tradeoff results or the result of the said comparison between the said first expected tradeoff result and the said second expected tradeoff result was impact neutral to the said allowable tradeoff threshold range.

5. A method as recited in claim 2 [c2], wherein the said method comprises:
a. setting an allowable range for the said strategic objective target value and saving the said allowable strategic objective range;
b. setting an allowable range for the said tradeoff threshold limit and storing the said allowable tradeoff threshold range;
c. saving the said modifications to the said interactive databases in the said original databases if the said second expected results or the result of the said comparison between the said first expected results and the said second expected was an improvement to achieving the said allowable strategic objective range and if the said second expected tradeoff result or the result of the said comparison between the said first expected tradeoff result and the said second expected tradeoff result did not violate the said allowable tradeoff threshold range;
d. not saving the said modifications to the said interactive databases into the said original databases if the said second expected results or the result of the said comparison between the first expected results and the second expected result was a detriment to achieving the said allowable strategic objective range or the said second expected tradeoff result or the result of the said comparison between the said first expected tradeoff result and the said second expected tradeoff result violated the said allowable tradeoff threshold range; and
e. saving or not saving, the choice of saving or not saving to be determined by the said entity, the said modifications to the said interactive databases into the said original databases if the said second expected results or the result of the said comparison between the said first expected results and the said second expected results was impact neutral to achieving the said allowable strategic objective range and if the said second expected tradeoff result or the result of the said comparison between the said first expected tradeoff result and the said second expected tradeoff result were impact neutral to the said allowable tradeoff threshold range.

6. A method as recited in claim 1 [c1], wherein said method comprises:
a. establishing and saving the different users and/or user levels for the said entity and the different authority levels associated to each said user and/or said user level, said authority levels having associated with them an amount or magnitude of allowable strategic objective impact a said user or said user level is authorized to implement;
b. saving the said modifications to the said interactive databases into the said original databases if the said second expected result or the result of the said comparison between the said first expected results and the said second expected results was an improvement to achieving the said strategic objective target value and if the amount or magnitude of the said second expected results or the amount or magnitude of the said comparison between the said first expected results and the said second expected results are within the said authority level of the said user or said user level as defined by the said allowable strategic objective impact;
c. not saving the said modifications to the said interactive databases into the said original databases if the said second expected results or the result of the said comparison between the said first expected results and the said second expected results was a detriment to achieving the said strategic objective target value or if the amount or magnitude of the said second expected results or the amount or magnitude of the said comparison between the said first expected results and the said second expected results are not within the said authority level of the said user or said user level as defined by the said allowable strategic objective impact; and
d. saving or not saving, the choice of saving or not saving to be determined by the said entity, the said modifications to the said interactive databases into the said original databases if the said second expected results or the result of the said comparison between the said first expected results and the said second expected results was impact neutral to achieving the said strategic objective target value and if the amount or magnitude of the said second expected results or the amount or magnitude of the said comparison between the said first expected results and the said second expected results are impact neutral based upon the said allowable strategic objective impact associated with the said authority level of the said user or said user level.

7. A method as recited in claim 2 [c2], wherein said method comprises:
a. establishing and saving the different users and/or user levels for the said entity and the different authority levels associated to each said user and/or said user level, said authority levels having associated with them an amount or magnitude of allowable strategic objective impact a said user or said user level is authorized to implement and an amount or magnitude of allowable tradeoff impact a said user or said user level is authorized to implement;
b. saving the said modifications to the said interactive databases into the said original databases if the said second expected results or the result of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold limit and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second tradeoff result or the amount or magnitude of the said comparison between the said first tradeoff result and the said second tradeoff result was within the said authority level of the said user or said user level as defined by the said allowable tradeoff impact;
c. not saving the said modifications to the said interactive databases into the said original databases if the said second expected results or the result of the said comparison between the said first expected results and the said second expected results was a deterioration to achieving the said strategic objective target value or if the said second expected tradeoff result or the result of the said comparison between the said first expected tradeoff result and the said second expected tradeoff result violated the said allowable tradeoff threshold limit or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second tradeoff result or the amount or magnitude of the said comparison between the said first tradeoff result and the said second tradeoff result was not within the said authority level of the said user or said user level as defined by the said allowable tradeoff impact; and
d. saving or not saving, the choice saving or not saving to be determined by the said entity, the said modifications to the said interactive databases into the said original databases if the said second expected results or the results of the said comparison between the said first expected results and the said second expected results was impact neutral to achieving the said strategic objective target value and if the said second tradeoff result or the result of the said comparison between the said first expected tradeoff result and the said second expected tradeoff result was impact neutral to the said allowable tradeoff threshold limit and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second tradeoff result or the amount or magnitude of the said comparison between the said first tradeoff result and the said second tradeoff result is impact neutral based upon the said allowable tradeoff impact associated with the said authority level of the said user or said user level.

8. A method as recited in claim 3 [c3], wherein said method comprises:
a. establishing and saving the different users and/or user levels for the said entity and the different authority levels associated to each said user and/or said user level, said authority levels having associated with them an amount or magnitude of allowable strategic objective impact a said user or said user level is authorized to implements;
b. saving the said modifications to the said interactive databases into the said original databases if the said second expected results or the results of the said comparison between the said first expected results and the said second expected results falls within the said allowable strategic objective range and if the amount or magnitude of the said second expected results or the amount or magnitude of the said comparison between the said first expected results and the said second expected results are within the said authority level of the said user or said user level as defined by the said allowable strategic objective impact;
c. not saving the said modifications to the said interactive databases into the said original databases if the said second expected results or the results of the said comparison between the said first expected results and the said second expected results falls outside of the said allowable strategic objective range or if the amount or magnitude of the said second expected results or the amount or magnitude of the said comparison between the said first expected results and the said second expected results are not within the said authority level of the said user or said user level as defined by the said allowable strategic objective impact; and
d. saving or not saving, the choice of saving or not saving to be determined by the said entity, the said modifications to the said interactive databases into the said original databases if the said second expected results or the results of the said comparison between the said first expected results and the said second expected results are impact neutral to the said allowable strategic objective range and if the amount or magnitude of the said second expected results or the amount or magnitude of the said comparison between the said first expected results and the said second expected results are impact neutral based upon the said allowable strategic objective impact associated with the said authority level of the said user or said user level.

9. A method as recited in claim 4 [c4], wherein said method includes the steps of:
a. establishing and saving the different users and/or user levels for the said entity and the different authority levels associated to each said user and/or said user level, said authority levels having associated with them an amount or magnitude of allowable strategic objective impact a said user or said user level is authorized to implement and an amount or magnitude of allowable tradeoff impact a said user or said user level is authorized to implement;
b. saving the said modifications to the said interactive databases into the said original databases if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results was within said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. not saving the said modifications to the said interactive databases into the said original databases if the said second expected results or if the results of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results was not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. saving or not saving, the choice of saving or not saving to be determined by the said entity, the said modifications to the said interactive databases into the said original databases if the said second expected results or the said comparison between the said first expected results and the said second expected results was impact neutral to the said strategic objective target value and if the said second expected tradeoff result or the result of the said comparison between the said first expected tradeoff result and the said second expected tradeoff result is impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result is impact neutral based upon the said allowable tradeoff impact associated with the said authority level of the said user or said user level.

10. A method as recited in claim 5 [c5], wherein said method includes the steps of:
a. establishing and saving the different users and/or user levels for the said entity and the different authority levels associated to each said user and/or said user level, said authority levels having associated with them an amount or magnitude of allowable strategic objective impact a said user or said user level is authorized to implement and an amount or magnitude of allowable tradeoff impact a said user or said user level is authorized to implement;
b. saving the said modifications to the said interactive databases into the said original databases if the said second expected results or the results of the said comparison between the said first expected results and the said second expected results falls within the said allowable strategic objective range and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. not saving the said modifications to the said interactive databases into the said original databases if the said second expected results or the results of the said comparison between the said first expected results and the said second expected results falls outside of the said allowable strategic objective range or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. saving or not saving, the choice of saving or not saving to be determined by the said entity, the said modifications to the said interactive databases into the said original databases if the said second expected results or the said comparison between the said first expected results and the said second expected results was impact neutral to the said allowable strategic objective range and if the said second expected tradeoff result or the result of the said comparison between the said first expected tradeoff result and the said second expected tradeoff result was impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result are impact neutral based upon the said allowable tradeoff impact associated with the said authority level of the said user or said user level.

11. A method as in any one of the preceding claims [c1][c2][c3][c4] [c5][c6][c7][c8][c9][c10], in which the said modifications to the said original databases are tracked by each said user, and said improvements and detriments to said strategic objective target values and/or said tradeoff limits are used to tangibly evaluate said user's performance and/or used to compensate and/or reward the said user for supporting the said strategic objective of the company.

12. A apparatus for determining if proposed modifications to existing planned activities are supportive of and consistent with an entity's strategic objective, wherein said apparatus includes:
a. user interface devices and modules operatively coupled to said apparatus;
b. a memory that stores databases and computer-readable code;
c. said databases including the original databases, modified original databases, interactive version of the said original databases and modified interactive databases;
d. a processor operatively coupled to said memory, said processor configured to implement said computer-readable code, said code configured to:
i. receive, load and store a desired target value for a primary strategic objective into the said memory or storage medium of the said apparatus, said apparatus having containing or access to the said entity's said databases and MIS;
ii. receive, load and store the calculation for a said entity's primary strategic objective measure in the said memory or storage medium of the said apparatus;
iii. modify the said existing planned activities not yet completed to be temporarily assumed to be completed over a planning period and temporarily store the said activity that is assumed completed in the said modified original databases in the said memory or storage medium of the said apparatus;
iv. execute the said MIS, or a duplicate version of the said MIS, over the said planning period using the said modified original databases to calculate the first expected strategic objective results as measured by the said primary strategic objective measure calculation and store the said first expected results in the said memory or storage medium of the said apparatus;
v. allow users to interact with the said interactive database version of the said original databases in order to modify the said interactive databases and store the said modified interactive databases temporarily in the said memory or storage medium of the said apparatus;
vi. execute the said MIS, or a duplicate version of the said MIS over the said planning period using the said modified interactive databases to calculate the second expected results as measured by the said primary strategic objective measure calculation and store the said second expected results in said memory or storage medium of the said apparatus;
vii. compare the said first expected results with the said second expected results to determine if the said modifications to the said modified interactive database when compared to the said modified original databases resulted in improvements, deterioration or was impact neutral to the said strategic objective target value and store and/or output of the said comparison to the said memory, said storage medium and/or output devices of the said apparatus;
viii. over-write the said original databases by loading and storing the said modifications to the said interactive databases into the said original databases and/or the said MIS in the said memory or storage medium of the said apparatus if the said second expected results or the results of the said comparison between the said first expected results and the said second expected results indicated improvements over the said first expected results to the said strategic objective target value;
ix. prevent the said original databases in the said memory or storage medium of the said apparatus from being over-written with the said modifications in the said modified interactive databases if the said second expected results or the results of the said comparison between the said first expected results and the said second expected results indicated a deterioration from the said first expected results to the strategic objective target value; and
x. either over-write or not over-write the said original databases in the said memory or storage medium of the said apparatus, the choice of over-writing or not over-writing to be determined by the said entity, with the said modifications to the said modified interactive databases if the said second expected results or the results of the said comparison between the said first expected results and the said second expected results are impact neutral to the said first expected results and to the said strategic objective target value.

13. An apparatus as recited in claim 12 [c12], wherein the said code is configured to:
a. receive, load and store in the said memory or storage medium of the said apparatus a said entity's primary tradeoff measure calculation;
b. receive, load and store in said memory or storage medium of the said apparatus an allowable tradeoff threshold limit;
c. execute the said MIS, or a duplicate version of the said MIS, to calculate the first expected tradeoff result, using the said modified original databases for the said planning period, as measured by the said primary tradeoff measure calculation, and load and store in the said memory or storage medium of the said apparatus the said first expected tradeoff result;
d. execute the said MIS, or a duplicate version of the said MIS, to calculate the second expected tradeoff result, using the said modified interactive databases for the said planning period, as measured by the said primary tradeoff measure calculation, and load and store in the said memory or storage medium of the said apparatus the said second expected tradeoff result;
e. compare the said first expected tradeoff result with the said second expected tradeoff result to determine the tradeoff impact the said modifications to the said interactive databases had on the said first expected tradeoff result and load and store the said tradeoff impact into the said memory or storage medium of the said apparatus;
f. over-write the said original databases in the said memory or storage medium of the said apparatus with the said modifications to the said interactive databases if the said second expected results or the results of the said comparison between the said first expected results and the said second expected results indicated improvements over the said first expected results to achieving the strategic objective target value and if the said tradeoff impact or the said second expected tradeoff result does not violate the said allowable tradeoff threshold limit;
g. prevent the said modifications to the said interactive databases from over-writing the said original databases in the said memory or storage medium of the said apparatus if the said second expected results or the results of the said comparison between the said first expected results and the said second expected results indicated deterioration from the said first expected results to the said strategic objective target value or if the said tradeoff impact or the said second expected tradeoff result violates the said allowable tradeoff threshold limit; and
h. over-write or not over-write the said original databases in the said memory or storage medium of the said apparatus, the choice of over-writing or not over-writing to be determined by the said entity, with the said modifications to the said modified interactive databases if the said second expected results or the results of the said comparison between the said first expected results and the said second expected results are impact neutral to the said first expected results and to the said strategic objective target value and if the said tradeoff impact or the said second expected tradeoff result is impact neutral to the said allowable tradeoff threshold limit.

14. An apparatus as recited in claim 12 [c12], wherein the said code is configured to:
a. receive, load and store preset allowable ranges for the said strategic objectives target value in the said memory or storage medium of the said apparatus that contains or has access to the said databases and said MIS;
b. over-write the said original databases in the said memory or storage medium of the said apparatus with the said modifications to the said interactive databases if the said second expected result or the results of the said comparison between the said first expected results and the said second expected results falls within the said allowable strategic objective range;
c. prevent the said modifications to the said interactive databases from over-writing the said original databases in the said memory or storage medium of the said apparatus if the said second expected results or the results of the said comparison between the said first expected results and the said second expected results falls outside of the said strategic objective measure allowable range; and
d. over-write or not over-write the said original databases in the said memory or storage medium of the said apparatus, the choice of over-writing or not over-writing to be determined by the said entity, with the said modifications to the said interactive databases if the said second expected results or the results of the said comparison between the said first expected results and the said second expected results was impact neutral to the said strategic objective allowable range.

15. An apparatus as recited in claim 13 [c13], wherein the said code is configured to:
a. receive, load and store preset ranges for the said allowable tradeoff threshold limit in the said memory or storage medium of the said apparatus;
b. over-write the said original databases in the said memory or storage medium of the said apparatus with the said modifications to the said interactive databases if the said second expected results or the results of the said comparison between the said first expected results and the said second expected results indicated improvements over the said first expected results and to the said strategic objective target value and if the said second expected tradeoff result or the result of the said comparison between the said first expected tradeoff result and the said second expected tradeoff result did not violate the said allowable tradeoff threshold range;
c. prevent the said modifications to the said interactive databases from over-writing the said original databases in the said memory or storage medium of the said apparatus if the said second expected results or the results of the said comparison between the said first expected results and the said second expected results indicated deterioration to the said first expected results and to the said strategic objective target value or if the said second expected tradeoff results or the result of the said comparison between the said first expected tradeoff result and the said second expected tradeoff result violates the said allowable tradeoff threshold range; and
d. over-write or not over-write the said original databases in the said memory or storage medium of the said apparatus, the choice of over-writing or not over-writing to be determined by the said entity, with the said modifications to the said interactive databases if the said second expected results or the results of the said comparison between the said first expected results and the said second expected results are impact neutral to the said first expected results and to the said strategic objective target value and if the said second tradeoff results or the result of the said comparison between the said first expected tradeoff result and the said second expected tradeoff result were impact neutral to the said allowable tradeoff threshold range.

16. An apparatus as recited in claim 13 [c13], wherein said code is configured to:
a. receive, load and store preset ranges for the said allowable tradeoff threshold limit in the said memory or storage medium of the said apparatus that contains or has access to the entity's said databases and said MIS;
b. receive, load and store preset ranges for the said strategic objective target value in the said memory or storage medium of the said apparatus;
c. over-write the said original databases in the said memory or storage medium of the said apparatus with the said modifications to the said interactive databases if the said second expected result or the results of the said comparison between the said first expected results and the said second expected results falls within the said allowable strategic objective range and if the said second expected tradeoff result or the result of the said comparison between the said first expected tradeoff result and the said second expected tradeoff result did not violate the said tradeoff threshold measure range;
d. preventing the said modifications to the said interactive databases from over-writing the said original databases in the said memory or storage medium of the said apparatus if the said second expected results or the result of the said comparison between the said first expected results and the said second expected results falls outside of the said allowable strategic objective range or if the said second expected tradeoff result or the result of the said comparison between the said first expected tradeoff result and the said second expected tradeoff result violated the said tradeoff threshold measure range; and
e. over-write or not over-write the said original databases in the said memory or storage medium of the said apparatus, the choice of over-writing or not over-writing to be determined by the said entity, with the said modifications to the said interactive databases if the said second expected results or the result of the said comparison between the said first expected results and the said second expected results was impact neutral to the said allowable strategic objective range and if the said second expected tradeoff results or the result of the said comparison between the said first expected tradeoff result and the said second expected tradeoff result were impact neutral to the said allowable tradeoff threshold range.

17. An apparatus as recited in claim 12 [c12], wherein the said code is configured to:
a. receive, load and store differing users and/or user levels for the said entity and the different authority levels associated to each said user and/or said user level, said authority levels having associated with them an amount or magnitude of allowable strategic objective impact that a said user or said user level is authorized to implement;
b. store the said modifications to the said interactive databases into the said original databases if the said second expected result or the result of the said comparison between the said first expected results and the said second expected results was an improvement to achieving the said strategic objective target value and if the amount or magnitude of the said second expected results or the amount or magnitude of the said comparison between the said first expected results and the said second expected results are within the said authority level of the said user or said user level as defined by the said allowable strategic objective impact;
c. not storing the said modifications to the said interactive databases into the said original databases if the said second expected results or the result of the said comparison between the said first expected results and the said second expected results was a detriment to achieving the said strategic objective target value or if the amount or magnitude of the said second expected results or the amount or magnitude of the said comparison between the said first expected results and the said second expected results are not within the said authority level of the said user or said user level as defined by the said allowable strategic objective impact; and
d. storing or not storing, the choice of storing or not storing to be determined by the said entity, the said modifications to the said interactive databases into the said original databases if the said second expected results or the result of the said comparison between the said first expected results and the said second expected results was impact neutral to achieving the said strategic objective target value and if the amount or magnitude of the said second expected results or the amount or magnitude of the said comparison between the said first expected results and the said second expected results are impact neutral based upon the said allowable strategic objective impact associated with the said authority level of the said user or said user level.

18. An apparatus as recited in claim 13 [c13], wherein said code is configured to:
a. load and store differing authority levels associated with an amount or magnitude of allowable impact to the said strategic objective measure, as measured by the said primary strategic objective measure, that different said users, or users levels, are authorized to direct the said code to over-write the said original databases with the said modified interactive databases based upon the said authority level of the said user, or said user level, and based upon the said allowable impact associated with the said authority level as compared to either the said second expected results or the said comparison between the said first expected results and the said second expected results and with an amount or magnitude of allowable impact to the said tradeoff measure, as measured by the said primary tradeoff measure, that different said users or said user levels, are authorized to direct said code to over-write the said original databases with the said modified interactive databases based upon the said authority level of the said user, or said user level, and based upon the said amount of allowable impact associated with the said authority level as compared to either the second expected tradeoff result or the said comparison between the said first expected tradeoff results and the said second expected tradeoff results;
b. storing the said modifications to the said interactive databases into the said original databases if the said second expected results or the result of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold limit and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second tradeoff result or the amount or magnitude of the said comparison between the said first tradeoff result and the said second tradeoff result was within the said authority level of the said user or said user level as defined by the said allowable tradeoff impact;
c. not storing the said modifications to the said interactive databases into the said original databases if the said second expected results or the result of the said comparison between the said first expected results and the said second expected results was a deterioration to achieving the said strategic objective target value or if the said second expected tradeoff result or the result of the said comparison between the said first expected tradeoff result and the said second expected tradeoff result violated the said allowable tradeoff threshold limit or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second tradeoff result or the amount or magnitude of the said comparison between the said first tradeoff result and the said second tradeoff result was not within the said authority level of the said user or said user level as defined by the said allowable tradeoff impact; and
d. storing or not storing, the choice storing or not storing to be determined by the said entity, the said modifications to the said interactive databases into the said original databases if the said second expected results or the results of the said comparison between the said first expected results and the said second expected results was impact neutral to achieving the said strategic objective target value and if the said second tradeoff result or the result of the said comparison between the said first expected tradeoff result and the said second expected tradeoff result was impact neutral to the said allowable tradeoff threshold limit and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second tradeoff result or the amount or magnitude of the said comparison between the said first tradeoff result and the said second tradeoff result is impact neutral based upon the said allowable tradeoff impact associated with the said authority level of the said user or said user level.

19. An apparatus as recited in claim 14 [c14], wherein said code is configured to:
a. load and store differing authority levels associated with an amount or magnitude of allowable impact, as measured by the said primary strategic objective measure, that different said users, or users levels, are authorized to direct the said code to over-write the said original databases with the said modified interactive databases based upon the said authority level of the said user, or said user level, and the said allowable impact associated with the said authority level as compared to either the said second expected results or the said comparison between the said first expected results and the said second expected results;
b. storing the said modifications to the said interactive databases into the said original databases if the said second expected results or the results of the said comparison between the said first expected results and the said second expected results falls within the said allowable strategic objective range and if the amount or magnitude of the said second expected results or the amount or magnitude of the said comparison between the said first expected results and the said second expected results are within the said authority level of the said user or said user level as defined by the said allowable strategic objective impact;
c. not storing the said modifications to the said interactive databases into the said original databases if the said second expected results or the results of the said comparison between the said first expected results and the said second expected results falls outside of the said allowable strategic objective range or if the amount or magnitude of the said second expected results or the amount or magnitude of the said comparison between the said first expected results and the said second expected results are not within the said authority level of the said user or said user level as defined by the said allowable strategic objective impact; and
d. storing or not storing, the choice of storing or not storing to be determined by the said entity, the said modifications to the said interactive databases into the said original databases if the said second expected results or the results of the said comparison between the said first expected results and the said second expected results are impact neutral to the said allowable strategic objective range and if the amount or magnitude of the said second expected results or the amount or magnitude of the said comparison between the said first expected results and the said second expected results are impact neutral based upon the said allowable strategic objective impact associated with the said authority level of the said user or said user level.

20. An apparatus as recited in claim 15 [c15], wherein said code is configured to:
a. load and store differing authority levels associated with an amount or magnitude of allowable impact to the said strategic objective measure, as measured by the said primary strategic objective measure, that different said users, or users levels, are authorized to direct the said code to over-write the said original databases with the said modified interactive databases based upon the said authority level of the said user, or said user level, and based upon the said allowable impact associated with the said authority level as compared to either the said second expected results or the said comparison between the said first expected results and the said second expected results and with an amount or magnitude of allowable impact to the said tradeoff measure, as measured by the said primary tradeoff measure, that different said users or said user levels, are authorized to direct said code to over-write the said original databases with the said modified interactive databases based upon the said authority level of the said user, or said user level, and based upon the said amount of allowable impact associated with the said authority level as compared to either the second expected tradeoff result or the said comparison between the said first expected tradeoff results and the said second expected tradeoff results;
b. storing the said modifications to the said interactive databases into the said original databases if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results was within said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. not storing the said modifications to the said interactive databases into the said original databases if the said second expected results or if the results of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results was not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. storing or not storing, the choice of storing or not storing to be determined by the said entity, the said modifications to the said interactive databases into the said original databases if the said second expected results or the said comparison between the said first expected results and the said second expected results was impact neutral to the said strategic objective target value and if the said second expected tradeoff result or the result of the said comparison between the said first expected tradeoff result and the said second expected tradeoff result is impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result is impact neutral based upon the said allowable tradeoff impact associated with the said authority level of the said user or said user level.

21. An apparatus as recited in claim 16 [c16], wherein said code is configured to:
a. load and store differing authority levels associated with an amount or magnitude of allowable impact to the said strategic objective measure, as measured by the said primary strategic objective measure, that different said users, or users levels, are authorized to direct the said code to over-write the said original databases with the said modified interactive databases based upon the said authority level of the said user, or said user level, and based upon the said allowable impact associated with the said authority level as compared to either the said second expected results or the said comparison between the said first expected results and the said second expected results and with an amount or magnitude of allowable impact to the said tradeoff measure, as measured by the said primary tradeoff measure, that different said users or said user levels, are authorized to direct said code to over-write the said original databases with the said modified interactive databases based upon the said authority level of the said user, or said user level, and based upon the said amount of allowable impact associated with the said authority level as compared to either the second expected tradeoff result or the said comparison between the said first expected tradeoff results and the said second expected tradeoff results;
b. storing the said modifications to the said interactive databases into the said original databases if the said second expected results or the results of the said comparison between the said first expected results and the said second expected results falls within the said allowable strategic objective range and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. not storing the said modifications to the said interactive databases into the said original databases if the said second expected results or the results of the said comparison between the said first expected results and the said second expected results falls outside of the said allowable strategic objective range or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. storing or not storing, the choice of storing or not storing to be determined by the said entity, the said modifications to the said interactive databases into the said original databases if the said second expected results or the said comparison between the said first expected results and the said second expected results was impact neutral to the said allowable strategic objective range and if the said second expected tradeoff result or the result of the said comparison between the said first expected tradeoff result and the said second expected tradeoff result was impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result are impact neutral based upon the said allowable tradeoff impact associated with the said authority level of the said user or said user level.

22. An apparatus as in one of claims 12 through 21 [c12][c13][c14] [c15][c16][c17][c18][c19][c20][c21] in which the said code is configured to track the said modifications to the said original databases by each said user and said improvements and detriments to said strategic objective target values and/or said tradeoff limits are used to tangibly evaluate said user's performance and/or used to compensate and/or reward the said user for supporting the said strategic objective of the entity.

23. A computer program embodied on a computer-readable medium for comparing a forecast of the expected results caused by the existing planned activities and a forecast of the expected results of any planned changes to the said existing planned activities in terms of a strategic objective measure in order to determine if the said planned changes are supportive and consistent with an entity's strategic objective, comprising a data structure instantiating code segment that establishes a storage record in memory having:
a. a desired target value for the said strategic objective;
b. a formula for calculating the said strategic objective measure;
c. an original database, a modified original database containing data assumed completed over the upcoming planning period, an interactive database version of the original database and a modified interactive database that contains the said planned changes to the original database and the data in the said modified interactive database is assumed completed over the said planning period;
d. a first expected results from the said formula for the said strategic objective measure as determined from the said modified original database that contains the said existing planned activities over the said planning period;
e. a second expected results from the said formula for the said strategic objective measure as determined from the said modified interactive database that contains the said planned changes to the said existing planned activities over the said planning period;
f. a difference between the said first expected results and the said second expected results; and
g. a feature for modifying the said original database of the said existing planned activities with the said planned changes to the said existing planned activities in the said memory if the said differences between the said first expected results and the said second expected results is an improvement to the said strategic objective measure and/or said target value or if the said second expected result is an improvement to the said strategic objective measure and/or said target value.

24. A computer program embodied on a computer-readable medium as recited in claim 23 [c23], wherein the said forecasts comprises a data structure instantiating code segment that establishes a storage record in memory having:
a. a tradeoff threshold measure;
b. a tradeoff threshold limit;
c. a first expected tradeoff result as determined from the said original database that contains the said existing planned activities;
d. a second expected tradeoff result as determined from the said modified databases that contains the said planned changes to the said existing planned activities;
e. a difference between the said first expected tradeoff result and the said second expected tradeoff result; and
f. a feature for modifying the said databases of the said existing planned activities with the said changed existing planned activities in the said memory if the said differences between the said first expected results and the said second expected results is an improvement to the said strategic objective measure and/or said target value or if the said second expected result is an improvement to the said strategic objective measure and/or the said target value and the said differences between the said first expected tradeoff results and the said second expected tradeoff results are positive or if the said second expected tradeoff result does not violate the said tradeoff threshold limit.

25. A computer program embodied on a computer-readable medium as recited in claim 23 [c23], wherein the said forecast comprises a data structure instantiating code segment that establishes a storage record in memory having:
a. a range of acceptable strategic objective measures; and
b. a feature for modifying the said databases of the said existing planned activities with the said planned changes to the said existing planned activities in the said memory if the said differences between the said first expected results and the said second expected results are within the said range of acceptable strategic measures or if the said second expected result is are within the said range of the acceptable strategic measures.

26. A computer program embodied on a computer-readable medium as recited in claim 24 [c24], wherein the said forecast comprises a data structure instantiating code segment that establishes a storage record in memory having:
a. a range of acceptable tradeoff threshold measures; and
b. a feature for modifying the said databases of the said existing planned activities with the said changed existing planned activities in the said memory if the said differences between the said first expected results and the said second expected results is an improvement to the said strategic objective measure or if the said second expected result is an improvement to the said strategic objective measure and/or the said target value and if the said differences between the said first expected tradeoff results and the said second expected tradeoff results or the said second expected tradeoff result is within the said range of acceptable tradeoff threshold measures.

27. A computer program embodied on a computer-readable medium as recited in claim 24 [c24], wherein the said forecast comprises a data structure instantiating code segment that establishes a storage record in memory having:
a. a range of acceptable tradeoff threshold measures;
b. a range of acceptable strategic objective measures; and
c. a feature for modifying the said databases of the said existing planned activities with the said planned changes to the said existing planned activities in the said memory if the said differences between the said first expected results and the said second expected results or the said second expected result is within the said range of acceptable strategic objective measures and if the said differences between the said first expected tradeoff results and the said second expected tradeoff results or the said second expected tradeoff result are within the said range of acceptable tradeoff threshold measures.

28. A computer program embodied on a computer-readable medium as recited in claim 23 [c23], wherein the said forecast comprises a data structure instantiating code segment that establishes a storage record in memory having:
a. a user specific authority level and/or user level authority level, said authority level having associated with them an amount or magnitude of allowable strategic impact a said user or said user level is authorized to implement; and
b. a feature for modifying the said databases of the said existing planned activities with the said planned changes to the said existing planned activities in the said memory if the said second expected results or the said differences between the said first expected results and the said second expected results are an improvement to the said strategic objective measure and/or the said target value and if the said amount or magnitude of change to the strategic objective measure is within the said user's authority level.

29. A computer program embodied on a computer-readable medium as recited in claim 24 [c24], wherein the said forecast comprises a data structure instantiating code segment that establishes a storage record in memory having:
a. a user specific authority level and/or user level authority level, said authority level having associated with them an amount or magnitude of allowable strategic impact a said user or said user level is authorized to implement and an amount or magnitude of tradeoff threshold measure impact a said user or said user level has the authority to implement; and
b. a feature for modifying the said databases of the said existing planned activities with the said changes to the said existing planned activities if the impact of the said changes are within the said user's authority level and the said second expected results or the said difference between the said first expected results and the said second expected results are an improvement to the said strategic objective measure and/or the said target value and if the said differences between the said first expected tradeoff results and the said second expected tradeoff results or the said second expected tradeoff result does not violate the said tradeoff threshold limit.

30. A computer program embodied on a computer-readable medium as recited in claim 25 [c25], wherein the said forecast comprises a data structure instantiating code segment that establishes a storage record in memory having;
a. user specific authority level and/or user level authority level, said authority level having associated with them an amount or magnitude of allowable strategic impact a said user or said user level is authorized to implement; and
b. a feature for modifying the said databases of the said existing planned activities with the said planned changes to the said existing planned activities if the said changes are within the said user's authority level and if the said second expected result or the said differences between the said first expected results and the said second expected results fall within the said allowable strategic objective ranges.

31. A computer program embodied on a computer-readable medium as recited in claim 26 [c26], wherein the said forecast comprises a data structure instantiating code segment that establishes a storage record in memory having:
a. a user specific authority level and/or user level authority level, said authority level having associated with them an amount or magnitude of allowable strategic impact a said user or said user level is authorized to implement and an amount or magnitude of tradeoff threshold measure impact a said user or said user level has the authority to implement; and
b. a feature for modifying the said databases of the said existing planned activities with the said planned changes to the said existing planned activities if the said changes are within the said user's authority level and if the said second expected results or the said differences between the said first expected results and the said second expected results are an improvement to the said strategic objective measure and/or the said target value and if the said tradeoff measure or the said difference between the said first tradeoff measure and the said second tradeoff measure falls within the said tradeoff threshold ranges.

32. A computer program embodied on a computer-readable medium as recited in claim 27 [c27], wherein the said forecast comprises a data structure instantiating code segment that establishes a storage record in memory having:
a. a user specific authority level and/or user level authority level, said authority level having associated with them an amount or magnitude of allowable strategic impact a said user or said user level is authorized to implement and an amount or magnitude of tradeoff threshold measure impact a said user or said user level has the authority to implement; and
b. a feature for modifying the said databases of the said existing planned activities the said changes to the said existing planned activities if the said second expected result or the said differences between the said first expected results and the said second expected results fall within the said allowable strategic objective ranges and if the said differences between the said first expected tradeoff results and the said second expected tradeoff results or the said second expected tradeoff result falls within the said tradeoff threshold ranges.

33. A computer program embodied in a computer-readable medium as in one of claims 23 through 32 [c23][c24][c25][c26][c27][c28] [c29][c30][c31][c32] wherein the said forecast comprises a data structure instantiating code segment that establishes a storage record in memory having the said modifications to the said original databases associated by each said user, and said improvements and detriments to said strategic objective target values and/or said tradeoff limits are used to tangibly evaluate said user's performance and/or used to compensate and/or reward the said user for supporting the said strategic objective of the said entity.

34. A device and system for determining if proposed modifications to existing planned activities are supportive of and consistent with an entity's strategic objective, said device and system comprising:
a. a means for receiving, loading and storing the code for calculating a strategic objective measure into the memory or storage device of a computer that contains or can access an entity's original databases and MIS if the said strategic objective measure does not already exist within the said databases or said MIS;
b. a means for receiving, loading and storing a desired target value for the said strategic objective measure into the said memory or storage medium of the said computer;
c. a means for temporarily modifying the said original databases to assume that the activities yet to be completed have been completed over a planning period and storing the said modified databases in the said memory or storage medium of the said computer;
d. a means for accessing the said MIS, or a copy of the said MIS, and utilizing the said modified databases to calculate the first expected results as measured by the said strategic objective measure over the said planning period and loading and storing the said first expected results in the said memory or storage medium of the said computer;
e. a means for loading and storing an interactive version of the said original databases in the said memory or storage medium of the said computer, wherein users are allowed to modify the said interactive databases and then temporarily storing the said modified interactive databases into the said memory or storage medium of the said computer;
f. a means for accessing the said MIS, or a copy of the said MIS, and utilizing the said modified interactive databases to calculate the second expected results as measured by the said strategic objective measure over the said planning period and loading and temporarily storing the said second expected results in the said memory or storage medium of the said computer;
g. a means for comparing the said first expected results with the said second expected results to determine if the said modifications to the said interactive databases caused an improvement, a deterioration or was impact neutral to achieving the said strategic objective target value and temporarily storing and/or outputting the said comparison in the said memory, said storage medium and/or output device of the said computer;
h. a means for accessing the said modifications to the said interactive databases and loading and storing the said modifications to the said interactive databases into the said original databases and/or the said MIS in the said memory or storage medium of the said computer if the said second expected results or the results of the said comparison between the said first expected results and the said second expected results was an improvement to achieving the said strategic objective target value;
i. a means for preventing the said modifications to the said interactive databases from being loaded and stored in the said original databases and/or the said MIS in the said memory or storage medium of the said computer if the said second expected results or the results of the said comparison between the said first expected results and the said second expected results was a detriment to the achievement of the said strategic objective target value;
j. a means for accessing the said modifications to the said interactive databases and either loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results was impact neutral to achieving the said strategic objective target value; and
k. a means for periodically loading and storing the said modifications to the said interactive database into the said modified database and into the said interactive database if the said modifications were loaded and stored in the said original databases and repeating c, d, e, f, g, h, i, and j above.

35. A device and system as recited in claim 34 [c34], wherein said device and system comprises:
a. a means for receiving a tradeoff measure calculation and loading and storing the code for calculating the said tradeoff measure into the said memory or storage medium of the said computer that contains or has access to the said entity's databases and said MIS;
b. a means for receiving an allowable tradeoff threshold limit for the said tradeoff measure and loading and storing said allowable tradeoff threshold limit into the said memory or storage medium of the said computer that contains or has access to the said entity's databases and said MIS;
c. a means for accessing the said MIS, or a copy of the said MIS, and utilizing the said modified databases to calculate the first expected tradeoff result as measured by the said tradeoff measure and loading and storing the said first expected tradeoff result into the said memory or storage medium of the said computer that contains or has access to the said entity's databases and said MIS;
d. a means for accessing the said MIS, or a copy of the said MIS, and utilizing the said modified interactive databases to calculate the second expected tradeoff result as measured by the said tradeoff measure and loading and storing the said second expected tradeoff result into the said memory or storage medium of the said computer that contains or has access to the said entity's databases and said MIS;
e. a means for comparing the said first expected tradeoff result with the said second expected tradeoff result to determine if the modifications to the said interactive databases caused an improvement, a deterioration or was impact neutral to the said first tradeoff result and loading and storing the said the result of the said comparison between the said first expected tradeoff result and the said second expected tradeoff result into the said memory, said storage medium and/or said output device of the said computer that contains or has access to the said entity's databases and said MIS;
f. a means for accessing the said modifications to the said interactive databases and loading and storing the said modifications to the said interactive databases into the said original databases and/or said MIS in the said memory or storage medium of the said computer if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold limit;
g. a means for preventing the said modifications to the said interactive databases from being loaded and stored in the said original databases and/or said MIS in the said memory or storage medium of the said computer if the said second expected results or the results of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff threshold limit; and
h. a means for accessing the said modifications to the said interactive databases and either loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results was impact neutral to achieving the said strategic objective target value and if the said second expected tradeoff result or the result of the said comparison between the said first expected tradeoff result and the said second expected tradeoff result were impact neutral to the said allowable tradeoff threshold limit.

36. A device and system as recited in claim 34 [c34], wherein the said device and system comprises:
a. a means for receiving allowable ranges for the said strategic objective target value and loading and storing the said allowable strategic objective ranges in the said memory or storage medium of the said computer that contains or has access to the said entity's said databases and said MIS;
b. a means for accessing the said modifications to the said interactive databases and loading and storing the said modifications to the said interactive databases into the said original databases and/or said MIS in the said memory or storage medium of the said computer if the said second expected results or the results of the said comparison between the said first expected results and the said second expected results falls within the said allowable strategic objective ranges;
c. a means for preventing the said modifications to the said interactive databases from being loaded and stored into the said original databases and/or the said MIS in the said memory or storage medium of the said computer if the said second expected results or the results of the said comparison between the said first expected results and the said second expected results falls outside of the said allowable strategic objective ranges; and
d. a means for loading and storing or not loading and not storing, the choice of loading and storing or not loading and not storing to be determined by the said entity, the said modifications to the said interactive databases into the said original databases and/or said MIS in the said memory or storage medium of the said computer if the said second expected results or the results of the said comparison between the said first expected results and the said second expected results was impact neutral to the said allowable strategic objective ranges.

37. A device and system as recited in claim 35 [c35], wherein the said device and system comprises:
a. a means for receiving a range for the said allowable tradeoff threshold limit and loading and storing the said allowable tradeoff range in the said memory or storage medium of the said computer that contains or has access to the said entity's said databases and said MIS;
b. a means for accessing the said modifications to the said interactive databases and loading and storing the said modifications to the said interactive databases into the said original databases and/or said MIS in the said memory of the said computer if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff range;
c. a means for preventing the said modifications to the said interactive databases from being loaded and stored in the said original databases and/or the said MIS in the said memory of the said computer if the said second expected results or the results of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff range; and
d. a means for accessing the said modifications to the said interactive databases and either loading and storing or not loading and not storing, the choice of loading and storing or not loading and not storing to be determined by the said entity, the said modifications to the said interactive databases into the said original databases and/or said MIS in the said memory or storage medium of the said computer if the said second expected results or the results of the said comparison between the said first expected results and the said second expected results was impact neutral to achieving the said strategic objective target range and if the said second expected tradeoff result or the results of the said comparison between the said first expected tradeoff result and the said second expected tradeoff result were impact neutral to the said allowable tradeoff range.

38. A device and system as recited in claim 35 [c35], wherein the said device and system comprises:
a. a means for receiving an allowable range for the said strategic objective target value and loading and storing the said allowable strategic objective range in the said memory or storage medium of the said computer that contains or has access to the said entity's said databases and said MIS;
b. a means for receiving an allowable range for the said allowable tradeoff threshold limit and loading and storing the said allowable tradeoff range into the said memory or storage medium of the said computer that contains or has access to the said entity's said databases and said MIS;
c. a means for accessing the said modifications to the said interactive databases and loading and storing the said modifications to the said interactive databases into the said original databases and/or said MIS in the said memory or storage medium of the said computer if the said second expected results or the results of the said comparison between the said first expected results and the said second expected results falls within the said allowable strategic objective range and if the said second expected tradeoff result or the results of the said comparison between the said first expected tradeoff result and the said second expected tradeoff result did not violate the said allowable tradeoff range;
d. a means for preventing the said modifications to the said interactive databases from being loaded and stored into the said original databases and/or said MIS in the said memory or storage medium of the said computer if the said second expected results or the results of the said comparison between the said first expected results and the said second expected results falls outside of the said allowable strategic objective range or if the said second expected tradeoff result or the result of the said comparison between the said first expected tradeoff result and the said second expected tradeoff result violated the said allowable tradeoff range; and
e. a means for accessing the said modifications to the said interactive databases and either loading and storing or not loading and not storing, the choice of loading and storing or not loading and not storing to be determined by the said entity, the said modifications to the said interactive databases into the said original databases and/or said MIS in the said memory or storage medium of the said computer if the said second expected results or the results of the said comparison between the said first expected results and the said second expected results was impact neutral to the said allowable strategic objective range and if the said second expected tradeoff result or the result of the said comparison between the said first expected tradeoff result and the said second expected tradeoff result was impact neutral to the said allowable tradeoff range.

39. A device and system as recited in claim 34 [c34], wherein said device and system comprises:
a. a means for receiving, loading and storing in the said memory or storage medium of the said computer, different users and/or user levels for the said entity, and different authority levels associated to each said user, and/or said user level, said authority levels having associated with them an amount or magnitude of allowable strategic objective impact a said user or said user level is authorized to implement;
b. a means for loading and storing the said modifications to the said interactive databases in the said original databases and/or said MIS in the said memory or storage medium of the said computer if the said second expected results or the results of the said comparison between the said first expected results and the said second expected results indicated improvements to achieving the said strategic objective target value and if the amount or magnitude of the said second expected results or the amount or magnitude of the said comparison between the said first expected results and the said second expected results are within the said authority level of the said user or said user level as defined by the said allowable strategic objective impact;
c. a means for preventing the said modifications to the said interactive databases from being loaded and stored in the said original databases and/or said MIS in the said memory or storage medium of the said computer if the said second expected results or the results of the said comparison between the said first expected results and the said second expected results was a detriment to achieving the said strategic objective target value or if the amount or magnitude of the said second expected results or the amount or magnitude of the said comparison between the said first expected results and the said second expected results are not within the said authority level of the said user or said user level as defined by the said allowable strategic objective impact; and
d. a means for loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results was impact neutral to achieving the said strategic objective target value and if the amount or magnitude of the said second expected results or the amount or magnitude of the said comparison between the said first expected results and the said second expected results are impact neutral based upon the said allowable strategic objective impact associated with the said authority level of the said user or said user level.

40. A device and system as recited in claim 35 [c35], wherein said device and system comprises:
a. a means for receiving, loading and storing in the said memory or storage medium of the said computer, different users and/or user levels for the said entity, and different authority levels associated to each said user, and/or said user level, said authority levels having associated with them an amount or magnitude of allowable strategic objective impact a said user or said user level is authorized to implement and an amount or magnitude of allowable tradeoff impact a said user or said user level is authorized to implement;
b. a means for loading and storing the said modifications to the said interactive databases into the said original databases and/or the said MIS in the said memory or storage medium of the said computer if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff threshold limit and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second tradeoff result or the amount or magnitude of the said comparison between the said first tradeoff result and the said second tradeoff result was within the said authority level of the said user or said user level as defined by the said allowable tradeoff impact;
c. a means for preventing the said modifications to the said interactive databases from being loaded and stored into the said original databases and/or the said MIS in the said memory or storage medium of the said computer if the said second expected results or the result of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff threshold limit or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second tradeoff result or the amount or magnitude of the said comparison between the said first tradeoff result and the said second tradeoff result was not within the said authority level of the said user or said user level as defined by the said allowable tradeoff impact; and
d. a means for loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results was impact neutral to achieving the said strategic objective target value and if the said second tradeoff result or the result of the said comparison between the said first expected tradeoff result and the said second expected tradeoff result was impact neutral to the said allowable tradeoff threshold limit and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second tradeoff result or the amount or magnitude of the said comparison between the said first tradeoff result and the said second tradeoff result is impact neutral based upon the said allowable tradeoff impact associated with the said authority level of the said user or said user level.

41. A device and system as recited in claim 36 [c36], wherein said device and system comprises:
a. a means for receiving, loading and storing in the said memory or storage medium of the said computer, different users and/or user levels for the said entity, and different authority levels associated to each said user, and/or said user level, said authority levels having associated with them an amount or magnitude of allowable strategic objective impact a said user or said user level is authorized to implement;
b. a means for accessing the said modifications to the said interactive databases and loading and storing the said modifications to the said interactive databases into the said original databases and/or said MIS in the said memory or storage medium of the said computer if the said second expected results or the results of the said comparison between the said first expected results and the said second expected results falls within the said allowable strategic objective range and if the amount or magnitude of the said second expected results or the amount or magnitude of the said comparison between the said first expected results and the said second expected results are within the said authority level of the said user or said user level as defined by the said allowable strategic objective impact;
c. a means for preventing the said modifications to the said interactive databases from being loaded and stored into the said original databases and/or the said MIS in the said memory or storage medium of the said computer if the said second expected results or the results of the said comparison between the said first expected results and the said second expected results falls outside of the said allowable strategic objective range or if the amount or magnitude of the said second expected results or the amount or magnitude of the said comparison between the said first expected results and the said second expected results are not within the said authority level of the said user or said user level as defined by the said allowable strategic objective impact; and
d. a means for loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results are impact neutral to the said allowable strategic objective range and if the amount or magnitude of the said second expected results or the amount or magnitude of the said comparison between the said first expected results and the said second expected results are impact neutral based upon the said allowable strategic objective impact associated with the said authority level of the said user or said user level.

42. A device and system as recited in claim 37 [c37], wherein said device and system comprises:
a. a means for receiving, loading and storing in the said memory or storage medium of the said computer, different users and/or user levels for the said entity, and different authority levels associated to each said user, and/or said user level, said authority levels having associated with them an amount or magnitude of allowable strategic objective impact and an amount or magnitude of allowable tradeoff impact a said user or said user level is authorized to implement;
b. a means for accessing the said modifications to the said interactive databases and loading and storing the said modifications to the said interactive databases into the said original databases and/or said MIS in the said memory or storage medium of the said computer if the said second expected results or the results of the said comparison between the said first expected results and the said second expected results was an improvement to achieving the said strategic objective target value and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results was within said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. a means for preventing the said modifications to the said interactive databases from being loaded and stored into the said original databases and/or said MIS in the said memory or storage medium of the said computer if the said second expected results or if the results of the said comparison between the said first expected results and the said second expected results was a detriment to achieving the said strategic objective target value or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results were not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. a means for accessing the said modifications to the said interactive databases and either loading and storing or not loading and not storing, the choice of loading and storing or not loading and not storing to be determined by the said entity, the said modifications to the said interactive databases into the said original databases and/or said MIS in the said memory or storage medium of the said computer if the said second expected results or the results of the said comparison between the said first expected results and the said second expected results was impact neutral to the said strategic objective target value and if the said second expected tradeoff result or the result of the said comparison between the said first expected tradeoff result and the said second expected tradeoff result is impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result is impact neutral based upon the said allowable tradeoff impact associated with the said authority level of the said user or said user level.

43. A device and system as recited in claim 38 [c38], wherein said device and system comprises:
a. a means for receiving, loading and storing in the said memory or storage medium of the said computer, different users and/or user levels for the said entity, and different authority levels associated to each said user, and/or said user level, said authority levels having associated with them an amount or magnitude of allowable strategic objective impact and an amount or magnitude of allowable tradeoff impact a said user or said user level is authorized to implement;
b. a means for accessing the said modifications to the said interactive databases and loading and storing the said modifications to the said interactive databases into the said original databases and/or the said MIS in the said memory or storage medium of the said computer if the said second expected results or the results of the said comparison between the said first expected results and the said second expected results falls within the said allowable strategic objective range and if the said second expected tradeoff result or the result of the said comparison between the said first expected tradeoff result and the said second expected tradeoff result did not violate the said allowable tradeoff range and if the amount or magnitude of the said second expected results or the amount or magnitude of the said comparison between the said first expected results and the said second expected results are within the said authority level of the said user or said user level as defined by the said allowable strategic objective impact and if the amount or magnitude of the said second expected tradeoff result or the amount or magnitude of the said comparison between the said first expected tradeoff result and the said second expected tradeoff result was within the said authority level of the said user or said user level as defined by the said allowable tradeoff impact;
c. a means for preventing the said modifications to the said interactive databases from being loaded and stored into the said original databases and/or the said MIS in the said memory or storage medium of the said computer if the said second expected results or the results of the said comparison between the said first expected results and the said second expected results falls outside of the said allowable strategic objective range or if the said second expected tradeoff result or the result of the said comparison between the said first expected tradeoff result and the said second expected tradeoff result violated the said allowable tradeoff range or if the amount or magnitude of the said second expected results or the amount or magnitude of the said comparison between the said first expected results and the said second expected results are not within the said authority level of the said user or said user level as defined by the said allowable strategic objective impact or if the amount or magnitude of the said second expected tradeoff result or the amount or magnitude of the said comparison between the said first expected tradeoff result and the said second expected tradeoff result was not within the said authority level of the said user or said user level as defined by the said allowable tradeoff impact; and
d. a means for accessing the said modifications to the said interactive databases and either loading and storing or not loading and not storing, the choice of loading and storing or not loading and not storing to be determined by the said entity, the said modifications to the said interactive databases into the said original databases and/or the said MIS in the said memory or storage medium of the said computer if the said second expected results or the results of the said comparison between the said first expected results and the said second expected results was impact neutral to the said allowable strategic objective range and if the said second expected tradeoff result or the result of the said comparison between the said first expected tradeoff result and the said second expected tradeoff result was impact neutral to the said allowable tradeoff range and if the amount or magnitude of the said second expected results or the amount or magnitude of the said comparison between the said first expected results and the said second expected results are impact neutral based upon the said allowable strategic objective impact associated with the said authority level of the said user or said user level and if the amount or magnitude of the said second expected tradeoff result or the amount or magnitude of the said comparison between the said first expected tradeoff result and the said second expected tradeoff result are impact neutral based upon the said allowable tradeoff impact associated with the said authority level of the said user or said user level.

44. A device and system as in one of claims 34 through 43 [c34][c35] [c36][c37][c38][c39][c40][c41][c42][c43], wherein said device and system comprises a means in which the said modifications to the said original databases are tracked by each said user, and said improvements and detriments to said strategic objective target values and/or said tradeoff limits are used to tangibly evaluate said user's performance and/or used to compensate and/or reward the said user for supporting the said strategic objective of the said entity.
